(19) United States
(12) Patent Application Publication
(10) Pub. No.: US 2015/0136206 A1
(43) Pub. Date: May 21, 2015

(54) ROOFING TILE, ARRANGEMENT OF ROOFING TILES AND METHOD FOR MANUFACTURING A ROOFING TILE

(71) Applicant: Ecomol AG, Buchs (CH)

(72) Inventor: Cornelius Paul, Hamburg (DE)

(73) Assignee: Ecomol AG, Buchs (CH)

(21) Appl. No.: 14/398,863

(22) PCT Filed: May 7, 2013
(86) PCT No.: PCT/DE2013/000251

§ 371 Date: Nov. 4, 2014

(30) Foreign Application Priority Data
May 7, 2012 (DE) 10 2012 008 852.3

(51) Int. Cl. H02S 20/25; E04D 1/04; F24J 2/52

(52) U.S. Cl. CPC H02S 20/25; F24J 2/52; E04D 1/04
USPC 136/251; 136/259; 29/890.033; 29/825; 52/173.1

(57) ABSTRACT

A concrete roof tile having a panel-shaped base body made from cast material, is characterized in that the base body is furnished with at least two holes in which wires are routed. This facilitates the use thereof in conjunction with a solar panel.

In a method for manufacturing a concrete roof tile, a clay or concrete roof tile is digitised, the model is modified in such manner that a flat surface is created on an upper side thereof to enable a solar module to be mounted thereon, a mould is prepared from the model, in which concrete roof tile base bodies are cast, and one solar module is fastened to each base body.

The invention relates to a concrete roof tile having a panel-shaped base body made from a cast material, an arrangement of concrete roof tiles, and a method for manufacturing a concrete roof tile.

A distinction is made between roof tiles that are made by firing clay and loam, and roof tiles that are produced, preferably from concrete, by pressing or casting. Deformations can be created when such clay roof tiles are fired. Concrete roof tiles do not change their shape during the manufacturing process.

The object underlying the invention is that of further developing concrete roof tiles of such kind.

This object is solved with a species-related concrete roof tile in which the base body has at least two holes in which lines are routed.

The routing of lines in the base body of a concrete roof tile opens the way for a range of new options for placing solar panels designed to generate electricity or hot water in or on the base body of a concrete roof tile. By providing such holes in the base body of the concrete roof tile, it becomes possible to supply the solar panel with water or electricity. At the same time, the hole may be used for drainage. If two lines are routed at a distance from one another in the base body of the concrete roof tile, many new functions for which the concrete roof tile may be used become conceivable.

The provision of two holes in the base body describes one aspect of the invention. Besides this aspect, the subordinate claims describe other aspects of the invention which are essential to the invention even without this feature.

It is advantageous if the lines are electrical lines. This allows the wires that are routed freely on the inside of the roof to be kept very short, and it is immediately evident which lines must be connected to each other after the concrete roof tiles have been installed.

Particularly when wires or cables are routed in the holes, it is advantageous if the lines are insulated from the cast material. Suitable insulating material would be silicone, for example, or some other curable or permanently elastic material. The sealing material in the hole thus insulates against penetration by moisture.

It is advantageous if the holes form channels perpendicular to the panel-shaped surface of the base body. This makes it possible to route wires from the front of the concrete roof tile to the rear of the concrete roof tile without difficulty.

However, such holes may also help to reduce the weight of the concrete roof tile. Particularly when solar modules are set up on the base body, holes may be provided below the modules to reduce the weight of the base bodies without thereby impairing the function of the concrete roof tile.

Wires may be routed through these holes. However, the advantage of weight reduction is realised even if no wires are routed through the holes. It is advantageous if the holes are spaced and aligned in the direction of flow of the rainwater that is to drain through the base body. Then, the holes are not aligned horizontally side by side but one directly below the other or with an offset from each other on a line diagonal to the concrete roof tile in the direction of the flow of rainwater. If cables are routed through the holes, the distance from each hole to nearest roof batten can be made shorter. If cables or connectors are provided on the roof batten, only shorter cables are needed between the concrete roof tile and the connector, and it is clearly evident which cable must be attached to which connector.

In order to reduce weight, and particularly for cooling in the case of the base bodies of concrete roof tiles, it is proposed that the holes form channels along the length of the panel-shaped surface of the base body. These channels may be used for routing lines. However, they may also serve to allow the flow of a fluid such as coolant air or coolant water without the use of lines. Even empty channels with no cooling function are advantageous if their arrangement reduces the weight of the concrete roof tile without significantly affecting its stability.

Concrete roof tiles of such kind may be made from cast materials such as plastics. It is advantageous if the cast material is an inorganic cast material. Waterproof concrete types lend themselves particularly well to the production of concrete roof tiles.

A particular variation provides that the concrete roof tile comprises a solar module with a glass pane. An array (matrix) of crystalline solar cells or a matrix of thin film cells is particularly suitable for use as a solar module. The matrix then lies between the pane of glass and the base body of the concrete roof tile. In this way, the base body of the tile forms a stable, watertight base and the glass pane serves as a durable, weather-resistant covering for the concrete roof tile.

It is therefore advantageous if the solar roof tile comprises a base body of concrete, a sealing material disposed over the base body, a solar matrix mounted thereon and a pane of glass sheet arranged on top of the matrix. With this structure, it is possible for the glass pane to be less than 4 mm, preferably even less than 2 mm thick. At the same time, even uncured glass panes may be used.

Since concrete roof tiles can be manufactured from a cast material in any colour, it is proposed that the tile comprise a solar panel and that cast material have approximately the same colour as the solar module. The cast material may also be painted. Moreover, the concrete roof tile may also be covered by the solar module such that that essentially only solar panels are visible on the roof surface. However, if portions of the base body are still visible when looking down onto the roof surface, it is advantageous if at least these regions of the base body are the same colour as the solar module

The upper surface of the concrete roof tile, which is exposed to the elements, should be as flat as possible. Sometimes, this area is corrugated, creating water drainage channels. The rear sides of concrete roof tiles are also specially shaped to make them easier to fasten to a roof batten.

However, it is advantageous if a concrete roof tile comprises a solar module and tabs arranged on the side of the solar module. These make it possible for the solar module to be positioned panel on the base body of the concrete roof tile, or for the tile to be stabilised by the tabs. Even arranged transversely to the direction of flow of water, such tabs do not impair the function of the concrete roof tile if the tile has a solar module and the tabs do not protrude significantly above the top surface of the solar module, if at all. However, the presence of tabs on the base body of the concrete roof tile lends the tile greater stability and enables production of the lightest possible base bodies for concrete roof tiles with solar modules.

In order to make the installation of concrete roof tiles with solar modules easier, it is suggested to design the solar module for a maximum of 60 V, for example about 20 to 60 volts, and for a maximum output of 6 to 20 watts, for example about 8 to 12 watts of output. Since the output depends on solar radiation, only approximate data can be obtained. The figures reported relate to the output of the solar module under the Standard Test Conditions (STC) generally applicable for photovoltaic systems (temperature 25° C., radiation intensity 1000 W/m2, angle of incidence of radiation 48 degrees and light spectrum AM 1.5).

In order to be able to pool the output of individual concrete roof tiles, it is proposed that the roof tiles be connected to one another via a parallel circuit. This means that a feed line and a drain line are routed preferably parallel to a horizontal roof batten, and are connected to each other via a plurality of solar modules which are switched therebetween.

The feed line and the drain line are located several centimetres apart, for example 3 to 10 cm, to prevent short circuits and the associated risk of fire due to rodent damage, for example. It is advantageous if the feed line and the drain line are arranged on different, preferably opposite sides of the roof batten. The feed line and the drain line are then separated in one direction by the roof batten between them, and in the other direction by the distance between the battens. The current thus flows from the feed line to the drain line via multiple solar modules connected in parallel. Consequently, shading of a solar module will only cause the system output to fall by the output of the single solar module. Moreover, the voltage between the feed and drain lines remains constant, whereas the power or the current depends on the number of solar modules activated between the feed line and the drain line. Since the voltage remains constant, it is possible to configure powerful boost converters with low losses and high efficiency.

In order to avoid creating excessively large currents on the roof, it is suggested to combine the concrete roof tiles in blocks of 1 to 3 kW each, preferably about 2 kW. For example, 200 solar concrete roof tiles, each with a 10 W solar module, can be combined to form a 2 kW block. The 50 volt lines are then routed to a 2 kW inverter, which generates an AC voltage of e.g. 240 V AC or 380 V AC for injection into the AC power grid. Inverters with an output of 2 kW can each be connected in parallel again on the AC side.

In order to prevent short circuits, it is provided that the concrete roof tiles are placed between roof battens, cables are routed from the tiles to wires on the roof battens, and said wires are spaced more than 3 cm, preferably even more than 10 cm apart.

Concrete roof tiles are usually manufactured in very large numbers and with little variation for a large range of house roofing applications.

Such known manufacturing methods are suitable for minimizing the costs of centrally manufactured concrete roof tiles of the same shape. However, the object underlying the invention is to enable concrete roof tiles to be manufactured inexpensively in various shapes and in small quantities, for a single house roof for example.

This object is solved with a method for manufacturing a concrete roof tile in which a clay roof tile or concrete roof tile is digitised, the model is adapted such that a flat surface for mounting a solar module is created on the upper surface thereof, a mould is created for the model, concrete roof tile base bodies are cast in said mould, and one solar module is fastened to each base body.

This creates the capability of providing concrete roof tiles with solar modules, in which the shape of the base body is substantially the same as the tiles that are to be replaced, for a single roof. For this purpose, the tile to be replaced is modified, i.e., a flat surface is created on the face so that a solar panel can be mounted on a cast base body. The tile is preferably digitised beforehand, and then the model is modified. The effect of this is that the solar module is stabilised by the base body on which it rests, and a solar concrete roof tile is created that can replace conventional clay or concrete roof tiles. All connecting elements with other tiles, such as rabbets or grooves are retained so that the new concrete roof tile still fits mechanically in the old system.

The method is suitable for use as a decentralized production process for smaller batches in the vicinity of roofs on which conventional tiles are to be replaced by solar concrete roof tiles.

According to a simple variant of the method, the mould has a blister made from plastic. Such blisters can be produced at low cost and make it possible to cast the base moulds inexpensively. It is advantageous if the blisters are retained in an outer support mould such as a foam material. A further process variant provides that the moulds are made directly from foam. In this context, it is even possible to dispense with a blister if the foam material is smooth enough, so that the foam material itself constitutes the mould. The foam moulds have a specific surface area or are treated with a releasing agent to stop the concrete from sticking to them.

For simple manufacture of such solar modules, the cells of the solar module can be encapsulated in a plastic such as EVA, PVB, silicone, polyolefin or the like. In a process separate from the production of the concrete roof tile base body, the cells may thus be introduced into the potting material which protects the cells and enables said cells to be connected to the base bodies after the base bodies have been cast.

The encapsulating material may be pigmented or dyed so that the concrete roof tile looks like a red brick, for example. Low density colour pigments are particularly suitable for this. It is usually sufficient if the material is only partially pigmented or dyed to create the impression of a coloured concrete roof tile. The solar surface will then appear reddish on the outside, while still allowing light to pass through.

An advantageous procedure provides that a cell matrix of silicon cells with a sealing layer is embedded on the base body, a front pane of glass is placed on the sealing bed while it is still soft, and electrical connectors are fed through holes in the concrete roof tile. Alternatively, the individual layers can be deposited on the glass pane. Another advantageous procedure therefore provides that a cell matrix of silicon cells with a sealing layer is embedded on the front pane, then a sealing layer is applied to the concrete base body, the front pane with cell matrix is then placed on this on this sealing bed while it is still soft, and the electrical connections are passed through holes in the concrete roof tile.

In this way, some of the old, existing tiles be replaced with solar concrete roof tiles. This simple method of assembly by replacing and the non-hazardous protective extra-low voltage, the elimination of complicated planning (due to the parallel circuit) and the use of simple plug-in contacts make it possible even for someone without skill in the field to equip, for ex-ample, areas on the south side of his roof with solar roof tiles, to connect the roof tiles with cables, and have these connected to the household power supply by a qualified electrician.

Such solar concrete roof tiles may also consist of a brick material, metal, wood or the like. However, cast materials are particularly suitable.

Furthermore, a solar concrete roof tile does not necessarily have to be mounted on a roof. All surfaces that are exposed to the Sun are suitable, including for example walls and façades.

Thus, a concrete roofing tile is created that can be mechanically adapted simply to the existing stock of tiles (without getting into difficulties relating to the watertightness of the roof), and at the same time can serve as a carrier for a solar module. The concrete roof tile can preferably consist of as few parts as the other tiles (i.e. it does not include several thereof).

The production method should be applicable to absolutely any clay/concrete roof tile. This means that only the mould is changed, the rest of the production process remains completely unchanged. The impression and production process should be inexpensive enough for it to be suitable for use with small production runs.

Preferably, any concrete roof tile can be scanned, copied, and have a surface thereof “flattened”. This means that all rabbets, grooves, etc. (i.e. the mechanical fittings for the old system) are preserved, and a solar module may be installed on the flat surface. The concrete roof tiles are then cast in a casting process using a concrete that was specially developed for this purpose.

The special feature lies in the adaptive process, since it is not possible to replicate any clay/concrete roof tile for use as a solar roof tile with the previous methods. Earlier methods have all been limited to just a few types of concrete roof tile (at least in terms of what is financially feasible).

Accordingly, the roofer only has to be prepared for one mounting principle, which he can use for all concrete roof tile types, and not for one system from manufacturer A, the next system from manufacturer B, etc. On the contrary, since each tile can be digitally reproduced, it is possible even for people without any prior experience to use the product, simply by removing the old tiles from the roof and installing the new solar concrete roof tiles in their place.

The electrical system leads to a system that can interconnect many small modules without large electrical losses (at low cost). It is safe in the event of fire due to the protective extra-low voltage and it can be installed by people with no experience in the field.

Its performance is affected only minimally, if at all, by shading on the roof. It enables the solar modules to be fitted on any roof without complex electrical planning, and electrical losses still remain low.

Accordingly, the following combination is particularly advantageous: Cells are of small size, so each solar concrete roof tile generates about 50 V and 0.2 A. The many contact points may be kept very cheap due to the low currents involved. The solar concrete roof tiles are electrically connected in parallel. Consequently, the voltage is also low. Thus, the system can be installed by unqualified persons and is not dangerous in the event of fire. The low voltage is also another reason why the contact points can be kept very cheap (no protection is needed). An inverter is mounted on (or near) the roof, and from the 50 V DC voltage it generates an AC voltage of e.g. 240 V AC or 380 V AC for injection into the AC power grid.

The manufacturing process can also be used economically in small production runs and is applicable on site. This is solved with the casting process, or the correspondingly modified steps in module production.

The materials used, particularly the concrete and encapsulating materials, are durable. Unlike conventional solar modules, the “concrete module” is very rigid and thus unaffected by the effects of wind, snow, etc. This results in a further improvement of the durability

The stability of the concrete allows the glass used in the front to be much thinner (better transmissivity, lower costs, reduced weight).

An advantageous embodiment is illustrated in the drawing and will be described in the following.

In the drawing:

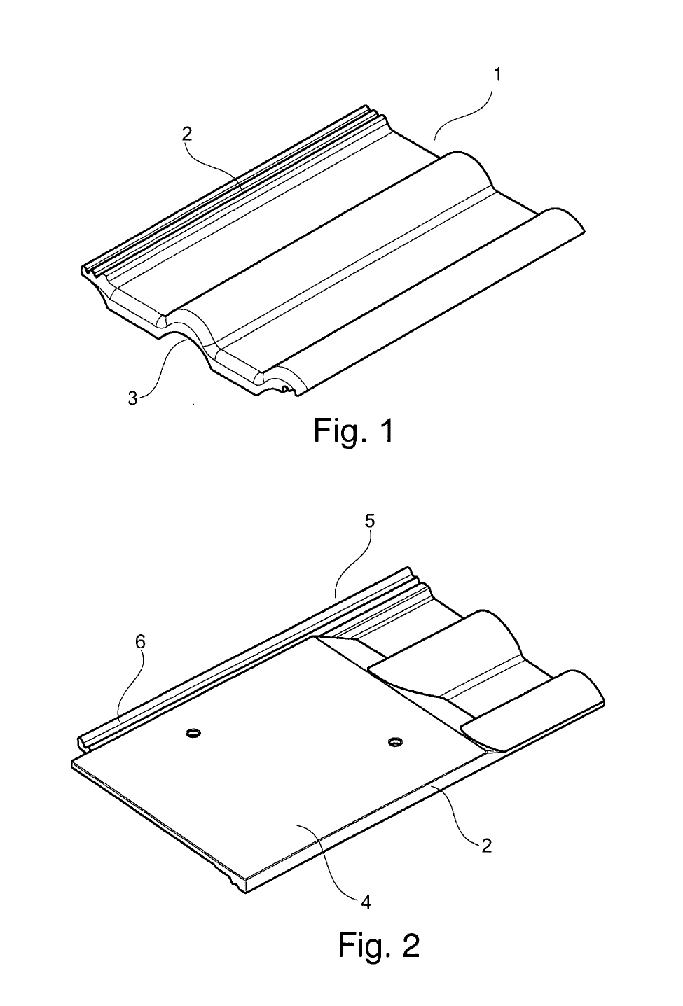

FIG. 1 shows a digital image of a concrete roof tile taken from a roof,

FIG. 2 is an enlarged image of a shape of the concrete roof tile of FIG. 1, which has been adapted to enable a solar module to be mounted,

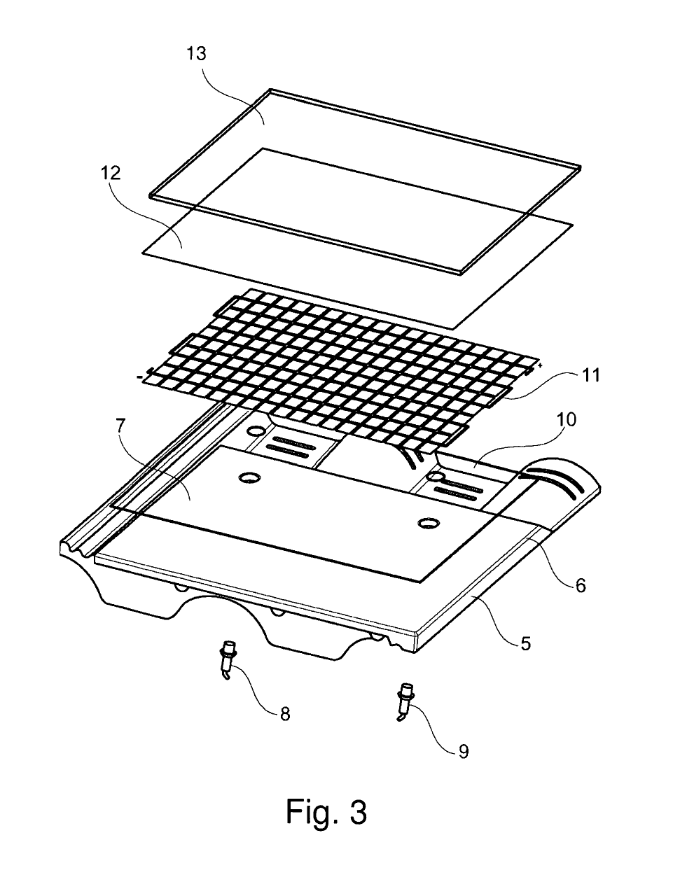

FIG. 3 is an exploded view of the tile of FIG. 2 as a concrete roof tile with solar module mounted,

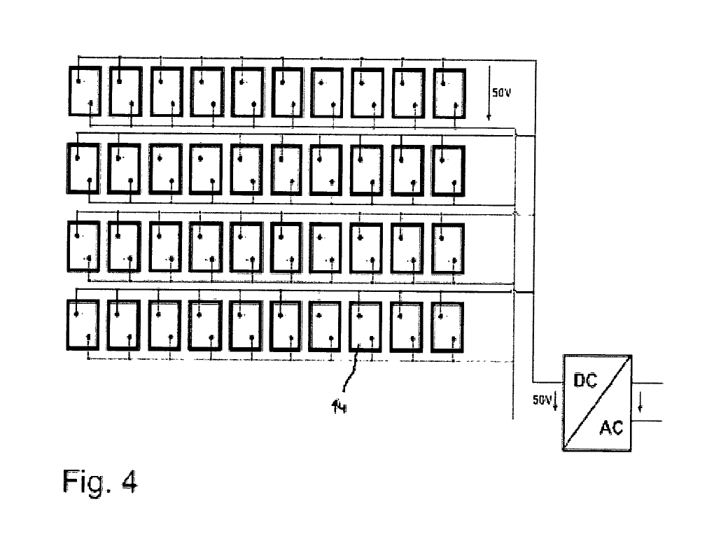

FIG. 4 shows a circuit for an array of concrete roof tiles on a roof,

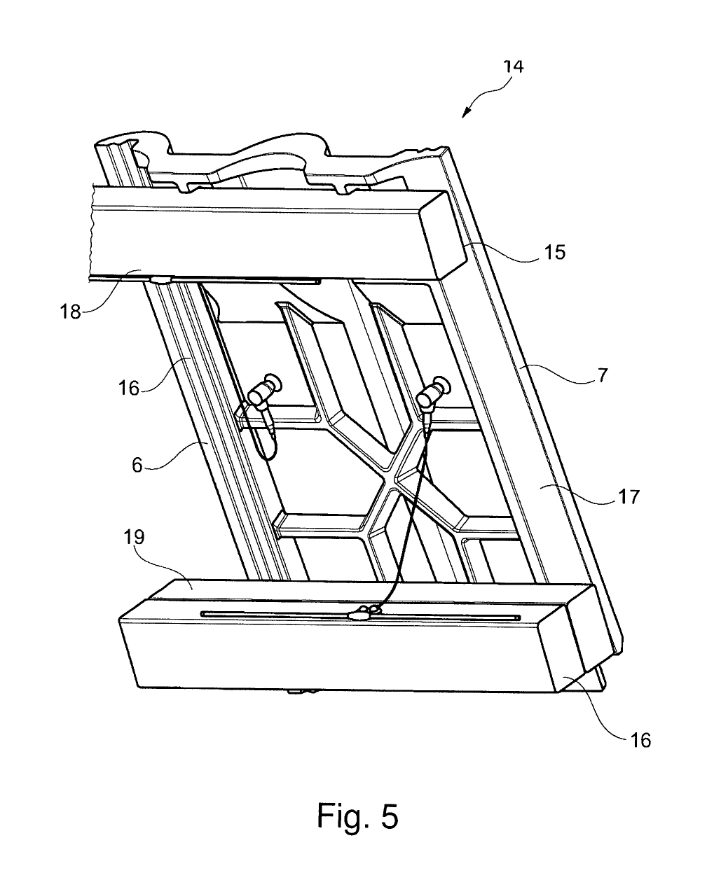

FIG. 5 is a perspective view of a solar concrete roof tile between two battens on a roof, and

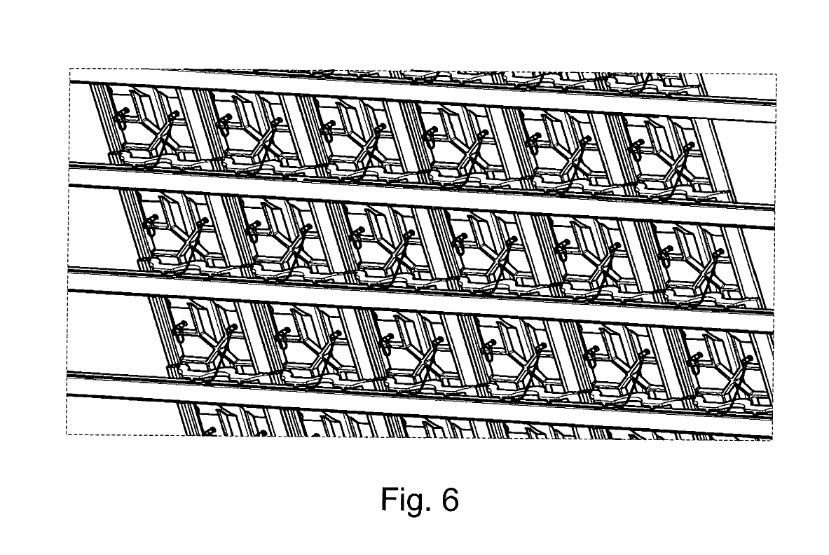

FIG. 6 is a rear view of a section of roof.

The roof tile 1 shown in FIG. 1 has an upper side 2 and an underside 3. The diagram in FIG. 1 is an illustration of a roof tile taken from a roof area that is to be retrofitted. To this end, the tile taken from the roof was digitised (3D scan) and damage was corrected in the scanned image. Alternatively a dataset from a tile manufacturer describing the shape of the tile may also be used.

In order to provide such a concrete roof tile 1 with a solar module, first the digital shape is modified so that a flat surface 4 is created for mounting a solar module, which flat surface is exposed to solar radiation after the reshaped concrete roof tile 5 has been mounted on the roof. For this, the digital image of the tile is digitally modified in such manner that later an optimal surface 4 can be provided for mounting the solar module on a concrete roof tile. All connectors to other tiles, such as rabbets or grooves, are retained, so that the new concrete roof tile still fits mechanically in the old system. Boreholes 6 and 7 are also provided.

Then, a positive form is produced from metal, by copy milling for example. This metal form used to produce the mould (negative mould) in a vacuum deep drawing process:

The moulds (negative forms) are deep drawn from plastic films and look like solid plastic blister packs. The metal form is suitable for producing many such blister forms (moulds). Negative form parts are also produced from Styrofoam, in which the blisters may be inserted. The blister forms are inserted in the Styrofoam form parts, then clamped in a metal frame, for example, and combined into blocks. Then, for example clamped in a metal frame and combined into blocks. Each of the forms has a filling opening and a riser as an opening, through which the air and excess casting material can escape. For demoulding, the plastic blister forms are taken out of the metal frame, and the halves of the mould are thus separated from the concrete roof tile body.

The cell matrices to be applied to the concrete roof tiles are produced centrally in large quantities and transported e.g. via parcel service to the production site for the concrete roof tile base bodies.

A special liquid silicone is used as the encapsulating agent. The first layer of silicone is applied and thermally crosslinked in advance by means of an automatic dispenser. The cell matrix is deposited on top of this and covered with a second layer of encapsulating agent by the dispenser. Then, the front glass plate (2 to 4 mm float glass) is placed on top, and thermal crosslinking is carried out again. The adhesion results in an optimal bond between the layers from the glass layer to the base body and at the same time creates a weather-resistant encapsulation of the solar matrix. The cell matrix may also be placed on the front glass pane in similar manner, and finally the concrete roof tile is placed over the cell matrix.

The method also works the other way round: A special, liquid silicone is used as the encapsulating material. The first silicone layer is applied to the front glass (2 to 4 mm float glass) by means of an automatic dispenser. Then the cell matrix is applied and thermally crosslinked. After this, the concrete base body is covered with a second layer of encapsulating material by the dispenser. The front glass pane including the cell matrix is placed on this, and thermally crosslinked again. The adhesion results in an optimal bond between the layers from the glass layer to the base body and at the same time creates a weather-resistant encapsulation of the solar matrix.

FIG. 3 shows contacts 8 and 9 connected with short cables, which can be inserted through holes 7 and 8 in base body 5, the blank of the concrete roofing tile. A potting layer of silicone is placed over this, in which solar matrix 11 is embedded. Another potting layer 12 of silicone is positioned over this, and a front glass pane 13 is placed on top.

Electrical cables that have been threaded through the holes and which were preferably furnished with contacts before they were passed through the holes in the base body, are now available on the rear of the base body. The cables are connected to the solar matrix.

Finally, the solar concrete roof tile is provided with a serial number, in the form of a data matrix code, for example, to ensure traceability and conformance with the standards.

Depending on its size, the solar roof tile produced in this way has a capacity from about 8 to 12 W. By using the plurality (about 50 to 100) of small silicon cells, the solar concrete roof tile emits a voltage of about 50 volts and a current of only about 0.2 amps. The circuit is shown diagrammatically in FIG. 4.

As shown in FIG. 5, these solar concrete roof tiles 14 are fastened between two roof battens 15 and 16 on the roof. In this context, one cable is led out through a hole 6 and one cable through a hole 7 in concrete solar roof tile 14 and each is connected to a cable 16 or 17 via a contact. The cables are rated for a maximum of 10 amperes and therefore only need to have a cross section of 4 mm². The spaced arrangement of holes 6 and 7 and cables 16 and 17 on the back of concrete roof tile 14 facilitates connection to the parallel cables 18 and 19.

The separate routing of cables 18 and 19 on the upper side and underside of the roof batten serves as effective protection against short circuits and thereby reduces the risk of fire. A fixed connection between short cables 16 and 17 and cables 18 and 19 forms two opposing cable strands, each with several spurs, to which the solar modules 14 can be connected directly.

Cables 18 and 19, between which a plurality of concrete roof tiles are connected separately, lead to an inverter 20, which is shown in FIG. 4. Such inverters 20, to each of which a plurality of strands with concrete solar roof tiles 14 are connected, may be installed for ex-ample under the roof cladding or close to the roof. The inverters are standardised to a power of 2 kW and an AC voltage output of 240V AC or 380V AC. Any number of them can therefore in turn be connected in parallel on the AC voltage level.

DC voltage output of e.g. 400 volts. Any number of them can therefore in turn be connected in parallel to a 400 volt rail. The 400 volt cable is routed to the cellar, for example, where it is converted to 400 Volt AC voltage and fed into the power grid.

1: Concrete roof tile (1) having a panel-shaped base body made from cast material, wherein the base body has at least two holes, in which lines are routed.

2: Concrete roof tile according to claim 1, wherein the lines are electric lines.

3: Concrete roof tile according to claim 1, wherein the lines are insulated from the cast material.

4: Concrete roof tile according to claim 1, wherein the holes form channels that extend perpendicularly to the panel-shaped alignment of the base body.

5: Concrete roof tile according to claim 1, wherein the holes form channels that extend lengthwise relative to the panel-shaped alignment of the base body.

6: Concrete roof tile according to claim 1, wherein the cast material is an organic cast material.

7: Concrete roof tile according to claim 1, wherein it comprises a solar module with a glass pane.

8: Concrete roof tile according to claim 1, wherein it comprises a base body made of concrete, a sealing material arranged on top of the base body, a solar matrix arranged on top of the sealing material, and a glass pane arranged on top of the solar matrix.

9: Concrete roof tile according to claim 8, wherein the glass pane has a thickness of less than 4 mm and is made from uncured glass.

10: Concrete roof tile according to claim 1, wherein it comprises a solar module and wherein the cast material is approximately the same color as the solar module.

11: Concrete roof tile according to claim 1, wherein it comprises a solar module and wherein tabs are arranged on the side of the solar module.

12: Concrete roof tile according to claim 1, wherein it comprises a solar module (11) that is designed for a maximum of 60 Volts and an output of about 6 to 20 Watts.

13: Arrangement of concrete roof tiles according to claim 1, wherein the concrete roof tiles (5) are connected to each other via a parallel circuit.

14: Arrangement according to claim 13, wherein the concrete roof tiles are combined into blocks, each with an output of 1 to 3 kW, preferably about 2 kW.

15: Arrangement according to claim 13, wherein the concrete roof tiles are arranged between roof battens, cables pass from the concrete roof tile to wires installed on the roof battens, and these wires are routed with a distance of more than 3 cm therebetween.

16: Method for manufacturing a concrete roof tile according to claim 1, wherein a clay roof tile or a concrete roof tile is modified such that a flat surface is created on the upper side thereof to enable a solar module to be mounted thereon, a mold is created from the model, in which the concrete roof tile base bodies are cast, and one solar module is fastened to each base body.

17: Method according to claim 16, wherein the mold comprises a blister made from plastic.

18: Method according to claim 16, wherein a cell matrix of silicon cells with a sealing layer is embedded on the base body, a front pane of glass is placed on the sealing bed while it is still soft, and electrical connectors are passed through holes in the concrete roof tile.

19: Method according to claim 16, wherein a cell matrix of silicon cells with a sealing layer is embedded on a front glass pane, a base body is placed on the sealing bed while it is still soft, and electrical connectors are passed through holes in the concrete roof tile.
